(19) United States
(12) Patent Application Publication
(10) Pub. No.: US 2007/0254809 A1
(43) Pub. Date: Nov. 1, 2007

(54) Pesticide carrier and products

(76) Inventors: Taylor Pursell, Birmingham, AL (US); Arthur R. Shirley JR., Florence, AL (US); Keith D. Cochran, Killen, AL (US); Timothy G. Holt, Florence, AL (US); Gregory S. Peeden, Killen, AL (US); Christopher B. Pace, Russellville, AL (US); Joseph M. Miller, Killen, AL (US)

Correspondence Address: MANELLI DENISON & SELTER, 2000 M STREET NW SUITE 700, WASHINGTON, DC, 20036-3307, US

(21) Appl. No.: 11/723,294

(22) Filed: Mar. 19, 2007

Related U.S. Application Data
(63) Continuation of application No. 10/460,650, filed on Jun. 13, 2003, now abandoned.
(60) Provisional application No. 60/388,295, filed on Jun. 14, 2002.

(51) Int. Cl. A01N 25/34; A01N 59/00; A01N 59/02; A01N 59/06; A01N 59/26; A01N 61/00; A01N 63/00; A01N 65/00

(52) U.S. Cl. 504/101; 424/408; 424/601; 424/610; 424/682; 424/719; 424/722; 424/725; 424/750; 504/118; 504/187; 504/188

(57) ABSTRACT

A pesticide carrier composition including a core particle having absorbent voids and/or pores on the particle surface, and/or a rough absorbent surface, and a pesticide release material that is water soluble and is present on the surface or absorbed within the surface of the core particle; and a pesticide product further including a pesticide present in one or more of a coating on the surface of the carrier composition or mixed with the pesticide release material

This is a continuation application of U.S. application Ser. No. 10/460,650 filed Jun. 13, 2003.

### BACKGROUND OF THE INVENTION

This invention relates to compositions serving as a carrier for controlled release of pesticides and a pesticide product including both the carrier and a pesticide. The controlled release includes a quick release that results in a lethal or significantly inhibiting application of the pesticide to the deleterious organism.

More particularly, the pesticide product comprises the carrier and a pesticide applied to the surface of the carrier or mixed with the release material of the carrier.

Accordingly, the present new pesticide carrier and product have been developed to control organisms that are deleterious to plants such as employed for agriculture, horticulture, lawns and gardens, and any other situation where control of such organisms is desired.

### BRIEF SUMMARY OF THE INVENTION

The present invention includes a pesticide carrier composition comprising a core particle that is absorbent and a coated or absorbed pesticide release material. The core particles may further be coated with a filler/release control agent.

The present invention further includes a pesticide product comprising the aforesaid carrier composition and a pesticide applied to the surface of the carrier composition or mixed with the pesticide release material of the carrier.

The pesticide release material is water soluble so that when the pesticide product is applied to plants or soil, natural precipitation or irrigation water will solubilize the pesticide release material, providing for a controlled quick release of the pesticide over coating or pesticide release material mixture, and thus deliver a lethal or significantly inhibiting application of the pesticide to one of more types of deleterious organisms. The quick delivery of the pesticide has the effect of reducing the total amount of pesticide to be effective, thus reducing costs and reducing the environmental impact.

### DETAILED DESCRIPTION OF THE INVENTION

The present pesticide carrier composition comprises:

(1) a core particle having (a) absorbent voids and pores at least on the surface, or (b) having a rough, absorbent surface, and

(2) a pesticide release material that is water soluble and is on the surface or absorbed within the surface of the core particle.

The core particle may be composed of granulated agglomerated smaller particles. The core particles may further be coated with a filler/release control agent (mixed or not mixed with the pesticide release material) to control the density of the core particle and solubility of the pesticide release material.

The pesticide product comprises (1) the carrier composition and (2) a pesticide or pesticide composition applied to the surface of the carrier composition and/or mixed with the pesticide release material of the carrier. Pesticides include herbicides, insecticides, fungicides and any other substance for controlling living organisms that are deleterious to plants.

The pesticide release material is water soluble so that when the pesticide product is applied to plants, insects, soil and other locations of deleterious organisms, then natural precipitation or irrigation water will solubilize the pesticide release material, providing for a controlled quick release of the pesticide over coating or pesticide release material mixture, and thus deliver a lethal or significantly inhibiting application of the pesticide to one or more types of deleterious organisms.

The preferred density of the pesticide product is a weight density of from 15 to 65 lb/ft³ and a more preferred weight density of 20 to 40 lb/ft³ and a most preferred weight density of 20 to 30 lb/ft³. The pesticide product has a preferable size of 0.20 mm to 25 mm and a more preferable size of 1 mm to 4 mm and a most preferable size of 1 mm to 2 mm.

Core particles containing pores or voids have voids at the surface, such that the voids at the surface are between 10-200 microns in cross-sectional diameter, with the surface being coated in an amount preferably of 40-100%, more preferably 75-100% and most preferably 90-100% of the voids with the pesticide release material. The core particles include one of more of the following materials: perlite, shredded newspaper, saw dusts, cedar fines, spruce fines, hardwood fines, limestone, zeolite, peat moss, peanut hulls, calcium carbonate, wood chips including pine chips and fines, attapulgite clay (atta clay), bentonite, vermiculite, cotton lint, ground corn cobs, corn cob flower, Metrecz absorbent and diatomaceous earth.

Release materials are water soluble and includes one or more of the following: ammonium sulfate, urea, di-ammonium phosphate, potassium chloride, calcium nitrate, potassium sulfate, zinc sulfate, aluminum sulfate, magnesium sulfate, manganese sulfate, sodium nitrate, potassium nitrate, copper sulfate, boric acid, borax (e.g., 5 mole borax), mono ammonium phosphate, calcium phosphate, and single and triple super phosphate. Other water soluble release materials are encompassed within the scope of this invention, particularly those conferring a growth benefit to plants such as a nutrient benefit.

The filler/release control agent includes the following: plant starches, protein gels, glues, gumming compositions, crystallizing compounds, gelling clays, and synthetic gel forming compounds; and other plant starches, protein gels and glues, gumming products, crystallizing compounds, gelling clays, and synthetic gel forming compounds also work as the filler/release control agent. These include but are not limited to the following: corn starch, rice starch, potato starch, wheat starch, tapioca starch, and any starch which contains the D-glucopyranose polymers, amylose and amylopectin; modified starch of the former listing (also including corn starch) by acetylation, ethylation, chlorination, acid hydrolysis, or enzymatic action which yield starch acetates, esters, and ethers; starch phosphate, an ester made from the reaction of a mixture of orthophosphate salts (sodium dihydrogen phosphate and disodium hydrogen phosphate) with any of the listed (also including corn starch) starch/or starches; gelatin as made by hydrolysis of collagen by treating raw materials with acid or alkali; glue as made from any of the following: collagen, casein, blood, and vegetable protein such as that of soybeans; gumming products such as cellulosics, rubber latex, gums, terpene resins, mucilages, asphalts, pitches, hydrocarbon resins; crystallizing compounds such as sodium silicate, phosphate cements, calcium-oxide cements, hydraulic cements (mortar, gypsum); gelling clays in the form of very fine powders; synthetic gel forming compounds such as polysulfide sealants, polyethylene, isobutylene, polyamides, polyvinyl acetate, epoxy, phenolformaldehyde, urea formaldehyde, polyvinyl butyral, cyanoacrylates, and silicone cements. Plant starches work particularly well, especially corn and wheat starches.

The pesticide of the present pesticide product includes one or more insecticides such as 0,0-diethyl O-(2-isopropyl-6 methyl-4 pyrimidinyl) phosphorothioate, one or more herbicides such as 2,4-dichlorophenoxyacetic acid, one or more fungicides such as ferric-di-methyl-dithiocarbamate or combination of one or more insecticides, herbicides and fungicides. Further examples of pesticides and organism control substances (including selective growth regulators) are 2-(2-Methyl-4-chlorophenoxy)propionic acid; 2-Methyl-4-chlorophenoxyacetic acid; 3,6-Dichloro-o-anisic acid; Pyrethrins; 2-chloro-4-ethylamino-s-triazine; Benefin: N-butyl-N-ethyl-alpha, alpha, alpha, trifluoro-2,6-dinitro-p-toluidine; Trifluralin: alpha, alpha, alpha, trifluoro-2, trifluoro-2,6-dinitro-N,N-dipropyl-p-toluidine; Dithiopyr 3,5-pyridenedicarbothiocic acid, 2-(difluoromethyl)-4-(2-methylpropyl)-6-(trifluoromethyl)-S, S-dimethyl ester; Chlorpyrifos(O,O-diethyl-O-(3,5,6-trichloro-2-pyridyl)phosphorothioate; O,O-Diethyl S-(2-(ethylthio)ethyl)phosphorodithioate; (2,2,2-trichloro-1-hydroxethyl)phosphonate; 1-((6-chloro-3-pyridinyl)methyl)-N-nitro-2-imidazolidinimine; Cyano(4-fluoro-3-phenoxyphenyl)methyl 3-(2,2-dichloroethenyl)-2,2-dimethylcyclopropane carboxylate; (2,4,6,8-tetramethyl-1,3,5,7-tetraoxycyclo-octane); Prodiamine, (N3, N3-Di-n-propyl-2,4-nitro-6(trifluoromethyl)-m-phenylenediamine)

A further embodiment of the present pesticide product includes the addition of one or more fertilizer compounds to the release material, previously absorbed by the carrier or provided as one or more additional coatings. The fertilizer compounds include nitrogen compounds, phosphorous compounds and potassium compounds. The nitrogen compounds include urea, ammonia, ammonium nitrate, ammonium sulfate, calcium nitrate, diammonium phosphate, monoammonium phosphate, potassium nitrate and sodium nitrate. The phosphorous compounds include diammonium phosphate, monoammonium phosphate, calcium phosphate, monopotassium phosphate, dipotassium phosphate, tetrapotassium pyrophosphate, and potassium metaphosphate. The potassium compound includes potassium chloride, potassium nitrate, potassium sulfate, monopotassium phosphate, dipotassium phosphate, tetrapotassium pyrophosphate, and potassium metaphosphate.

Similarly, additional nutrients may be added. These include all secondary nutrients (for example, sulfur, calcium, and magnesium) and all micronutrients (for example boron, copper, iron, manganese, molybdenum, zinc), as well as growth regulators such as, but not limited to, potassium azide, 2 amino-4-chloro-6-methylpyrimidine, N-(3,5-dichlorophenyl)succinimide, 3-amino-1,2,4 triazole and nitrification regulators such as, but not limited to, 2-chloro-6-(trichloromethyl)pyridine, sulfathiazole, dicyandiamide, thiourea, and guanylthiourea.

A full combined nitrogen-phosphorus-potassium (NPK) fertilizer can be made by using compounds of nitrogen, phosphorus and potassium to provide proportions of N-P-K, for example, of 29-3-4, 16-4-8, 10-10-10, 15-5-10, 15-0-15, 22-3-14, 20-28-5, 35-3-9, 38-3-4 and 12-6-6. In particular, NPK fertilizer may contain nitrogen from urea, nitrogen and phosphorus from monoammonium phosphate and/or diammonium phosphate, and potassium from potassium chloride in various proportions and concentrations, and then blending the product with a filler to provide proportions of NPK for example, of 29-3-4, 16-4-8, 10-10-10, 15-5-10, 15-0-15, 22-3-14, 20-28-5, 35-3-9, 38-3-4 and 12-6-6.

The carrier composition of the present invention is produced by two types of granulation methods. The first method includes combining a slurry of pesticide release material and water with small core particles and granulating the mixture to form larger agglomerated particles which are the carrier.

The second method includes overcoating large core particles with a slurry of pesticide release material and water, using a granulation method. The filler/release control agent may be mixed with the pesticide release material. A particularly useful filler/release control agent has the additional benefit of being a granulation aid.

While a pesticide product may be desired having a low density, it often desirable to have a much more difficult to attain, high density product. The high density product is a concentrated product, having improved handling characteristics and the possibility of additionally controlled pesticide release properties

The present invention includes a higher density product.

To produce such a higher bulk density product, core particles of highly absorbent material is employed to thus absorb a high amount of release material which may or may not include a filler/release control agent.

To produce the highest density product, the present invention includes the process embodiment of, for example, the steps of 1) introducing water to core particles of absorbent material (i.e., absorbent particles) to result in absorption of water within the absorbent material, 2) heating the absorbent particles and water to transform the water within the absorbent particles to steam and thus expand the core particles, 3) introducing the heated absorbent, core particles to a release material which may or may not include a filler/release control agent, 4) granulating the foregoing to solidify and harden the mixture, resulting in the agglomeration of absorbent core particles into carrier granules, and 5) drying the carrier granules.

Perlite, usually available and used in an expanded (i.e., “popped”) form, is highly absorbent and may be employed as the material of the core particles to produce the higher density, concentrated product.

To produce the highest density, concentrated product using perlite, important process features of the present invention are employed, including the following: 1) expanded (“popped”) perlite is further steam exfoliated beyond its normal popped form to allow better penetration and filling of its interspatial regions by the release material either mixed or not mixed with filler/release control agent (the amount of steam exfoliation is controlled to regulate the size of interspatial regions and thus the density of the product); 2) solutions and slurries of the foregoing are maintained around 30 to 98% concentration, preferably 50 to 99% concentration and most preferably 62 to 99%, to minimize voids formed from evaporation during the processing (For particular carrier core particles, lesser concentrations may be employed to control the density of the product, such as for example, when using ammonium sulfate solutions, the solution is preferably 60-70% concentration and more preferably 62 to 67% concentration); and 3) the small perlite particles containing release material with or without filler/release control agent, are granulated together to form dense, particles.

Exfoliated and/or expanded (popped) perlites product particularly good pesticide carrier compositions and pesticide products. The inside microstructure of an exfoliated and/or expanded perlite particle is comparable to a honeycomb type arrangement; the individual cells indicate diameters of 10 to 200 microns, with a preferred range being 25 to 150 microns, and the most preferred range being 40 to 100 microns. As such, the exfoliated and/or expanded perlite used can have a loose weight density of from 2 to 20 lb/ft³ with a preferred range of 2 to 10 lb/ft³ and a most preferred range of 2 to 6 lb/ft³.

The pesticide may be mixed in with the release material or coated on the carrier. The pesticide may be mixed in or coated using the following exemplary equipment: drum coater, pan coater, fluid-bed coater, pugmill mixer, homogenizer, industry recognized mixers such as pin mixers and screw feeders, and other industry recognized coating apparatuses.

The pesticide may be applied to the carrier particles by any of the following exemplary methods:

1. Apply liquid pesticide with a spray nozzle

a. Air atomizing nozzle

b. Hydraulic nozzle

c. Others

2. Apply waxy pesticide material with a heated spray nozzle

a. Air atomizing nozzle

b. Hydraulic nozzle

c. Others

3. Apply a sticking agent to carrier and apply over-coating of pesticide in powder form

4. Apply pesticides during the granulation of carrier

5. Apply pesticides in other industry recognized methods

Pesticides may be applied in the following exemplary forms:

| Pesticide | Form of Pesticide |
|---|---|
| Lamda | Meltable Solid |
| Trimec | Powder/Sticking Agent |
| Sevin | Powder or Liquid |
| Permethrin | Liquid |
| Dimension | Meltable Solid |
| Barricade | Powder |
| Atrazine | Powder |

When the pesticide is applied in a powder form, a sticking agent may be applied to the surface of the carrier. Examples of sticking agents include one or more of the following: di-propylene glycol (DPG), soybean oil, starch, sugar solution.

The following examples/tests show how the present invention has taken the above concepts and developed them into a unique pesticide carrier and method of making and using same.

While ammonium sulfate has been employed as the release material in specific amounts in granulation Examples 1-4, the release material may in general be mixed in with the core particles in an amount preferably 1-30 wt % concentration, more preferably 2-20 wt %, and most preferably 4-11 wt %.

Additionally, in the following examples/tests, the following information is provided to better describe employed materials:

| | Manufacturing | | Bulk Density |
|---|---|---|---|
| Material | Company | Particle Size | (lb/ft3) |
| 1440 AC Corncob | Green Products Company | 0.71 mm | 25 |
| | Conrad, Iowa | | |
| Southern Yellow Pine 1047 | American Wood Fibers | 0.43 mm | 16 |
| | Schofield, WI | | |
| Cedar Fines | American Wood Fibers | 0.75 mm | 8 |
| | Schofield, WI | | |
| Attapolgite Clay (Atta Clay) | generic | 50% less than | 56 |
| | | 74 micron | |
| Ammonium Sulfate | Honeywell, Inc. | 1.28 mm | 65 |
| CO-60 | Hopewell, VA | | |
| K-500 ethylated corn starch | Grain Processing Corp. | 78% less than | 39 |
| | Muscatine IA | 74 micron | |
| B810 Corn Starch | Grain Processing Corp. | 92% smaller | 33 |
| | Muscatine IA | than 74 micron | |
| Midsol 50 Wheat Starch | Mid West Grain Products, | 80% less than | 37 |
| | Inc. | 74 micron | |

Additionally, the N-P-K (15-15-15) employed in the tests is produced by Norsk Hydro ASA c/o Hydro Agri North America, Inc. The ingredients are ammonium nitrate, calcium phosphate, monoammonium phosphate (MAP), diammonium phosphate (DAP), potassium sulfate.

Permethrin is ((3-phenoxyphenyl)methyl-3-(2,2-dichlorovinyl)-2,2-dimethylcyclopropanecarboxylate).

TRIMEC™ is manufactured by PBI/GORDON Corporation, sold under the retail name of Weedout™ and is composed of dimethylamine salt of 2-(2-methyl-4-chlorophenoxy)propionic acid, dimethylamine of 2,4-dichlorophenoxyacetic acid, dimethylamine salt of dicamba (3,6-dichloro-O-anisic acid).

The following types of perlite were employed:

1. “perlite 3-S” having a median particle size of 0.36 mm by weight and bulk density of 3 lb/cubic ft;

2. “perlite #5” having a median particle size of 2.42 mm by weight and bulk density of 6.5 lb/cubic ft; and

3. “perlite #1” having a median particle size of 1.3 mm by weight and bulk density of 8 lb./cubic ft.

In tests where results of hardness and abrasion resistance are provided, these measurements were determined by the following methods:

Tennessee Valley Authority (TVA) (1) Crushing Test for hardness and TVA (2) Abrasion Resistance Test for abrasion resistance, as published in “Physical Properties of Fertilizers and Methods for Measuring Them”, Bulletin Y-147, October 1979, published by National Fertilizer Development Center, TVA, Muscle Shoals, Alabama.

Thus, the invention is demonstrated with reference to the following examples/tests, which are of an illustrative nature only and which are to be construed as non-limiting. See Table 1 for test results.

### EXAMPLES

### Examples of Processes for Making a Granular Carrier for Pesticides

### Example 1

### Pre-Mix and Drum Granulated Method

1. Ammonium sulfate was milled to less than 0.71 mm particles.
2. 200 grams of water were placed in a 1 liter beaker and heated to 200° F. on a lab hotplate.
3. While stirring the hot water using mechanical agitation, 400 grams of the ground ammonium sulfate particles were slowly added to produce a 67% solution of ammonium sulfate.
4. agitation of the solution was continued while the temperature was re-heated to 200° F.
5. the beaker was removed from the hotplate and 4.6 grams of corn starch (B-810) were added to the ammonium sulfate solution and mixed using a homogenizer.
6. 26 grams of the perlite 3-S were added to the ammonium sulfate/corn starch slurry.
7. the perlite 3-S was thoroughly mixed with the ammonium sulfate/corn starch in the 1 liter beaker.
8. the slurry was added to a rolling bed of recycled granules in a lab scale drum granulator while introducing heated air to evaporate the moisture and promote granulation.
9. the granules were dried in the drum granulator with heated air until all of the particles were free-flowing.
10. the material was removed from the lab scale drum granulator and screened to a desired product size.
11. the product was dried to the desired moisture concentration in a lab scale fluid-bed.
12. the ammonium sulfate granular carrier particles generated using this method would be coated with a pesticide

### Example 2

### Drum Over-Coating Granulation Method

1. Ammonium sulfate was milled to less than 0.71 mm particles.
2. 200 grams of water were placed in a 1 liter beaker and heated to 200° F. on a lab hotplate.
3. while stirring the hot water using mechanical agitation, 400 grams of the ground ammonium sulfate particles were slowly added to produce a 67% solution of ammonium sulfate.
4. the solution was continued to be agitated while the temperature was re-heated to 200° F.
5. the beaker was removed from the hotplate and 4.6 grams of corn starch (B-810) were added to the ammonium sulfate solution and mixed using a homogenizer.
6. 50 grams of perlite particles were placed in a lab scale drum granulator and the rolling bed of material was preheated to 100-120° F. indirectly by applying heat to the drum shell.
7. the mixture of ammonium sulfate/cornstarch was added to the rolling bed of preheated perlite in a lab scale drum granulator while introducing heated air to evaporate the moisture and promote granulation.
8. the granules were dried in the drum granulator with heated air until all of the particles were free-flowing.
9. the material was removed from the lab scale drum granulator and screened to a desired product size.
10. the product was dried to the desired moisture concentration in a lab scale fluid-bed.
11. the ammonium sulfate granular carrier particles generated using this method would be coated with a pesticide.

### Example 3

### Pre-Mix and Drum Granulated Method with the Addition of Attapulgite Clay

1. Ammonium sulfate was milled to less than 0.71 mm particles.
2. 200 grams of water were placed in a 1 liter beaker and heated to 200° F. on a lab hotplate.
3. while stirring the hot water using mechanical agitation, 400 grams of the ground ammonium sulfate particles were slowly added to produce a 67% solution of ammonium sulfate.
4. agitation of the solution was continued while the temperature was re-heated to 200° F.
5. the beaker was removed from the hotplate and 4.6 grams of corn starch (B-810) were added to the ammonium sulfate solution and mixed using a homogenizer.
6. 4.6 grams of attapulgite clay were added to the ammonium sulfate/corn starch mixture and mixed using a homogenizer.
7. 26 grams of perlite 3-S were added to the ammonium sulfate/corn starch/attapulgite clay slurry
8. the perlite 3-S was thoroughly mixed with the ammonium sulfate/corn starch/attapulgite clay in the 1 liter beaker.
9. the slurry was added to a rolling bed of recycled granules in a lab scale drum granulator while introducing heated air to evaporate the moisture and promote granulation.
10. the granules were dried in the drum granulator with heated air until all of the particles were free-flowing.
11. the material was removed from the lab scale drum granulator and screened to a desired product size.
13. the product was dried to the desired moisture concentration in a lab scale fluid-bed.
14. the ammonium sulfate granular carrier particles generated using this method would be coated with a pesticide.

### Example 4

### Drum Over-Coating Granulation Method with the Addition of Attapulgite Clay

1. Ammonium sulfate was milled to less than 0.71 mm particles.
2. 200 grams of water were placed in a 1 liter beaker and heated to 200° F. on a lab hotplate.
3. while stirring the hot water using mechanical agitation, 400 grams of the ground ammonium sulfate particles were slowly added to produce a 67% solution of ammonium sulfate.
4. agitation of the solution was continued while the temperature was re-heated to 200° F.
5. the beaker was removed from the hotplate and 4.6 grams of corn starch (B-810) were added to the ammonium sulfate solution and mixed using a homogenizer.
6. 4.6 grams of attapulgite clay were added to the ammonium sulfate/corn starch mixture and mixed using a homogenizer.
7. 50 grams of perlite particles were placed in a lab scale drum granulator and the rolling bed of material was preheated to 100-120° F. indirectly by applying heat to the drum shell.
8. the mixture of ammonium sulfate/cornstarch/attapulgite clay was added to the rolling bed of preheated perlite in a lab scale drum granulator while introducing heated air to evaporate the moisture and promote granulation.
9 the granules were dried in the drum granulator with heated air until all of the particles were free-flowing.
10. the material was removed from the lab scale drum granulator and screened to a desired product size.
11. the product was dried to the desired moisture concentration in a lab scale fluid-bed.
12. the ammonium sulfate granular carrier particles generated using this method would be coated with a pesticide.
   Further Examples/Tests
   Tests Determining Ammonium Sulfate Solubility
   Test 1:
   Materials
   150 g De-ionized H₂O
   150 g Ammonium sulfate (i.e., (NH₄)₂SO₄) fines
   Process
   eat H₂O to 200° F. and add ammonium sulfate (“AmSO₄”)while stirring
   At 225° F. the solution was taken off and poured onto a metal pan.
   The solution had a poor consistency and was very liquid consistency.
      Test 2:
      Materials
      150 g De-ionized H₂O
      Process
   Ammonium sulfate (“AmSO₄”) fines were added until no more AmSO₄ would go in or
   until it was supersaturated.
   began adding AmSO₄ when H₂O reached 200° F.
   200 g of AmSO₄ was initially added, then 50 g increments were added.
   additional increments were stopped at 300 g total AmSO₄ added.
   the solution was taken off heat at 215° F. and poured to a metal drum.
   the solution had a very good consistency (creamy thick, i.e., 33% H₂O and 67% AmSO₄)
      Test 3:
      Materials
      150 g De-ionized water
      400 g AmSO₄ fines
      Process
   heated water on hot plate
   added AmSO₄ when water reached 200° F.
   allowed stirring to continue to achieve good mixing
   removed from heat at 200° F.
   poured onto foil and had very good consistency at 73% AmSO₄ and 27% H₂O
      Test 4:
      Materials
      150 g De-ionized water
      225 g AmSO₄ fines
   Heat water on hot plate
   Add AmSO₄ when water reached 200° F.
   Allow stirring to continue to achieve good mixing
   Removed from heat at 210° F.
   Poured onto foil with very fluid consistency
      Test 5
      Materials
      150 g De-ionized water
      400 g AmSO₄ fines
      4.0 g Corn starch B810 (1%)
      Process
   heated water on hot plate
   added AmSO₄ when water reached 200° F.
   allowed stirring to continue to achieve good mixing
   added corn starch at 200° F.
   homogenized until smooth and poured onto foil at 178° F.
   good smooth consistency
      Test 6
      Materials
      150 g De-ionized water
      300 g AmSO₄ fines
      3.0 g Corn starch B810 (1%)
   heated water on hot plate
   added AmSO₄ when water reached 200° F.
   allowed stirring to continue to achieve good mixing
   added corn starch at 200° F.
   homogenized until smooth and poured on foil at 178° F.
   Good smooth consistency
      Test 7:
      Materials
      150 g De-ionized water
      300 g AmSO₄ industrial grade crystals
      Process
   heated water on hot plate
   added AmSO₄ when water reached 200° F.
   allowed stirring to continue to achieve good mixing
   removed from heat at 200° F.
   poor consistency with crystals separated out from liquid phase
      Test 8
      Materials
      150 g De-ionized water
      400 g AmSO₄ fines
      4 g Corn starch B810 (1%)
      25 g Perlite 3-S (5.8%)
      Process
   repeated Test 5 conditions
   once corn starch was homogenized into AmSO₄ solution, perlite was slowly stirred in
   poured onto foil and placed in lab oven to dry
   resulted in thick and “dry” material
      Test 9
      Materials
      150 g De-ionized water
      300 g AmSO₄ fines
      3 g Corn starch B810 (1%)
      23 g Perlite 3-S (7.0%)
      Process
   repeated of Test 6 conditions
   once corn starch was homogenized into AmSO₄ solution, perlite was slowly stirred in
   poured onto foil and placed in lab oven to dry
   resulted in thick and “dry” material
      Granulation Tests for Producing a Carrier for Pesticides
      Test 10
      Materials
      200 g De-ionized water
      400 g AmSO₄ fines
      4.3 g Corn starch B810 (1%))
      17 g Perlite 3-S
      Process
   repeated Test 9 conditions except less perlite
   once corn starch was homogenized into AmSO₄ solution, perlite was slowly stirred in
   drum granulated into resulting powder with no true granule formation
   resulting material was dried and used as recycle material for Test 11
      Test 11
      Materials
      200 g De-ionized water
      400 g AmSO₄ fines
      4.3 g Corn starch B810 (1%)
      17 g Perlite 3-S (4%)
      Process
   repeated Test 10 conditions
   employed recycle material in drum resulting from Test 10
   resulted in good granule growth when slurry poured on recycle
   resulted in material with bulk density of 41.9%
      Test 12
      Materials
      200 g De-ionized water
      400 g AmSO₄ fines
      8.6 g Corn starch B810 (2%)
      17 g Perlite 3-S (4%)
      Process
   doubled corn starch of Test 10
   created material in drum for recycle in Test 13
      Test 13
      Materials
      200 g De-ionized water
      400 g AmSO₄ fines
      8.6 g Corn starch B810 (2%)
      17 g Perlite 3-S (4%)
      Process
   recycled material resulting from Test 12 in drum
   poured slurry on rolling bed of recycle
   good granule growth
   resulting material had bulk density of 43.2% and hardness of crushing at 1.5-2 lb/ft³
      Test 14
      Materials
      200 g De-ionized water
      400 g AmSO₄ fines
      6.7 g Corn starch B810 (1.6%)
      26 g Perlite 3-S (6%)
      Process
   made slurry as in Test 13 but lower AmSO₄ and higher perlite
   created recycle in drum, however, some granule growth did occur
      Test 15
      Materials
      200 g De-ionized water
      400 g AmSO₄ fines (67%)
      6.7 g Corn starch B810 (1.6%)
      26 g Perlite 3-S (6%)
      Process
   repeated Test 14 conditions
   slurry was poured on rolling bed of recycle from Test 14
   resulted in material that did not agglomerate as well as Test 11 and 13 resulting materials
   granule growth occurred, but powder appeared greater than Test 11 and Test 13 results
   resulting material had:
   bulk density—39.7 lb/ft³
   abrasion—1.13%
   hardness—1.8 lb
      Test 16
      Materials
      250 g De-ionized water
      400 g AmSO₄ fines (62%)
      6.7 g Corn starch B810 (1.6%)
      26 g Perlite 3-S (6%)
      Process
   used same conditions as in Test 15 but changed ratio of AmSO₄ to H₂O
   resulted in good granule growth
   resulting material had:
   Bulk density—38.6 lb/ft³
   Abrasion—1.4%
   Hardness—2.4 lb
      Test 17
      Materials
      200 g De-ionized water
      400 g AmSO₄ fines (67%)
      9.2 g Corn starch B810 (2%)
      50 g Perlite #5 (10.9%)
      Process
   made water, AmSO₄ and corn starch in a slurry
   perlite was placed in bed of drum and slurry poured over bed while it was rolling
   heated to dry
   provided excellent granulation with very little recycle
   good coating of perlite
   resulting material had:
   Bulk density—26.3 lb/ft³
   Abrasion—0.05%
   Hardness—1.8 lb
      Test 18
      Materials
      200 g De-ionized water
      400 g AmSO₄ fines (67%)
      4.6 g Corn starch B810 (1%))
      50 g Perlite #5 (10.9)
      Process
   used same conditions as in Test 17 but resulted in a thinner solution
   the resulting material had:
   Bulk density—26.4 lb/ft³
   Abrasion—0.07%
   Hardness—1.6 lb
      Test 19
      Materials

200 g De-ionized water

400 g AmSO₄ fines (67%)

50 g Perlite #5 (11.1%)
made AmSO₄ solution and heated to 200° F.
placed perlite in drum and heated
poured AmSO₄ solution over rolling bed of perlite
added heat to dry and then placed material in lab fluid-bed to finish drying
resulting material had:
Bulk density—29.3 lb/ft³
Hardness—2.36 lb
Abrasion—0.06%
   Test 20
   Materials

200 g De-ionized water

400 g AmSO₄ fines (67%)

26 g Perlite 3-S (6.1%)

Process
repeated conditions of Test 16 without corn starch
Made AmSO₄ solution and heated to 200° F.
stirred in perlite
poured onto drum and granulated
dried using heat gun until free flowing
finished drying in lab fluid-bed
resulting material had:
Bulk density—35.1 lb/ft³
Hardness—1.60 lb
Abrasion—not enough resulting sample to measure
   Test 21
   Materials

200 g De-ionized water

550 g AmSO₄ (73.3%)

12.3 g Corn starch B810 (2%)

50 g Perlite #5 (8.2%)

Process
made AmSO₄ solution and it was very thick
Corn starch was homogenized into solution and the solution was thinned out
poured onto rolling bed of perlite
pre-dried in drum and finished drying in fluid-bed
resulting material had:
Bulk density—34.1 lb/ft³
Hardness—2.27 lb
Abrasion—0.22%
   Test 22
   Materials

200 g De-ionized water

550 g AmSO₄ (73.3%)

12.3 g Corn starch B810 (2%)

50 g Perlite 3-S (4/3%)

Process
used same procedure as Test 21 only used perlite 3-S
poured perlite onto rolling bed and sprayed water to keep dust down dried in drum
when slurry was poured over perlite it dried out quickly and minor granulation occurred, mostly resulting in powder
the powder was left in the drum for recycle and another slurry was made using the same components and poured over the perlite in rolling bed
granulation occurred similar to previous tests using perlite 3-S only resulted in higher quantity of granules
resulting material had:
Bulk density—39.1 lb/ft³
Hardness—2.56 lb
Abrasion—0.70%
   Test 23
   Materials

200 g De-ionized water

400 g AmSO₄ (67%)

9.2 g Wheat starch Midsol 50 (2%)

50 g Perlite #5 (10.9%)

Process
employed same conditions as Test 17
placed perlite #5 in rolling bed and poured AmSO₄/wheat starch over it
very good granulation occurred
dried in fluid-bed
resulted in material having:
Bulk density—30.9 lb/ft³
Hardness—1.65 lb
Abrasion—0.24%
   Test 24:
   Materials
   200 g De-ionized water
   400 g AmSO₄ fines
   9.2 g Corn starch B810
   50 g Perlite #1
   Process
repeated conditions of Test 17
resulted in material having:
Bulk density—27.6 lb/ft³
   Test 25
   Materials
   200 g De-ionized water
   400 g AmSO₄ fines (67%)
   9.2 g Wheat starch Midsol 50 (1.9%)
   75 g 1047 Southern Yellow Pine Chips (15.5%)
   Process
used same conditions as Test 17
pre-heated pine chips in drum
poured slurry over rolling bed
resulted in material having Bulk density 29.6 lb/ft³
   Test 26
   Materials
   200 g De-ionized water
   400 g AmSO₄ fines (67%)
   9.2 g Wheat starch Midsol 50 (2.1%)
   20 g milled (by hammer mill) newspaper (4.7%)
   Process
used same conditions as Test 17
poured slurry over newspaper in drum
resulting material had Bulk density 32.5 lb/ft³
   Test 27
   Materials
   200 g De-ionized water
   400 g AmSO₄ fines (67%)
   9.2 g Wheat starch Midsol 50 (1.9%)
   75 g 1440 AC corncob (15.5%)
   Process
used same conditions as Test 17
pre-heated cob in drum
poured slurry over rolling bed
resulted in material having Bulk density 34.0 lb/ft³
   Products made for Pesticide Over-Coating
   Test #28
   Materials
   200 g De-ionized water
   400 g AmSO₄ fines (67%)
   4.6 g Corn starch B810 (1%)
   50 g Perlite #5 (10.9)
   Process
resulted in material similar to that of Test 17
however, a thinner (more dilute) solution resulted
the resulting material had:
Bulk density—28.6 lb/ft³
Abrasion—0.07%
Hardness—1.6 lb
   Test #29
   Materials
   200 g De-ionized water
   400 g AmSO₄ fines
   9.2 g Corn starch B810 (2%)
   50 g Perlite #1
   Process
repeated the conditions of Test 17
resulting material had Bulk density—30.3 lb/ft³
   Test #30-1.6% CS/6% perlite/62% AmSO₄ solution:
   Materials
   250 g De-ionized water
   400 g AmSO₄ fines (62%)
   6.5 g Corn starch B810 (1.6%)
   26 g Perlite 3-S (6%)
   Process
repeated conditions of Tests 14 and 15
resulted in good granule growth with resulting material having—Bulk density—33.1 lb/ft³
   Test 31:
   Materials
   397.5 g Urea (“industrial”, i.e., containing no additives such as formaldehyde)—85% solution
   52.5 g Water
   28 g Perlite #1 (8.5%)
   3.2 g Corn starch B810 (1%)
   Process
made 85% solution and melted on hot plate
placed perlite in drum and pre-heated
homogenized corn starch into melt
poured over rolling bed of perlite
dried to free-flowing using heat gun
resulting material had Bulk density—24.6 lb/ft³
   Test 32:
   Materials
   297.5 g Urea—85% solution
   52.5 g Water
   25 g Perlite 3-S (7.6%)
   3.2 g Corn starch B810 (1%)
   Process
employed same process as in Test 31 and resulted in material having Bulk density—17.3 lb/ft³
   Test 33:
   Materials
   297.5 g Urea—85% solution
   52.5 g Water
   35 g Cedar fines (fine milled) (10%)
   3.2 g Corn starch B810 (1% CS)
   Process
employed same process as in Test 31 and resulted in material having Bulk density—20.6 lb/ft³
   Test 34:
   Materials
   297.5 g Urea—85% solution
   52.5 g Water
   75 g Attapolgite clay (Atta Clay) (20%)
   3.2 g Corn starch B810
   Process
employed same process as in Test 31 and resulted in material having Bulk density—32.8 lb/ft³
   Test 35:
   Materials
   297.5 g NPK 15-15-15—85% solution
   52.5 g Water
   28 g Perlite #1
   3.2 g Corn starch B810
   Process
made 85% solution NPK, homogenized in the corn starch, poured over rolling bed of perlite
resulting material had Bulk density—35.1 lb/ft³
   Test 36:
   Materials
   297.5 g NPK 15-15-15-85% solution 52.5 g Water
   25 g Perlite 3-S
   3.2 g Corn starch B810
   Process
made 85% solution NPK, homogenized in the corn starch, poured over rolling bed of perlite
resulted in material having Bulk density—34.4 lb/ft³
   Test 37:
   Materials
   297.5 g NPK 15-15-15—85% solution
   52.5 g Water
   35 g Cedar fines (10%)
   3.2 g Corn starch B810
   Process
made 85% solution of NPK, homogenized in the corn starch, poured over rolling bed of cedar fines
resulted in material having Bulk density—35.7 lb/ft³
   Test 38:
   Materials
   297.5 g NPK 15-15-15
   52.5 g Water
   75 g Attapolgite clay (Atta Clay) (20%)
   3.2 g Corn starch B810
   Process
made 85% solution of NPK, homogenized in the corn starch, poured over Atta Clay in drum
resulted in material having Bulk density—49.4 lb/ft³
   Test 39:
   Materials
   200 g De-ionized water
   400 g DAP fines (milled to smaller than 0.84 mm)
   75 g Perlite #1
   4.6 g Corn starch B810
   Process
made solution of DAP and water on hot plate
homogenized in the corn starch
pre-heated perlite in drum
poured DAP solution over rolling bed of perlite
dried to free-flowing in drum with heat gun
resulted in material having Bulk density—31.0 lb/ft³
   Test 40:
   Materials
   400 g DAP fines
   150 g De-ionized water
   35 g Perlite 3-S
   4.6 g Corn starch B810
   Process
used same conditions as Test 39
resulted in low viscosity material until dried in drum
resulted in material having Bulk density—37.4 lb/ft³
   Test 41:
   Materials
   400 g DAP
   150 g De-ionized water
   50 g Cedar fines
   4.6 g Corn starch B810
   Process
used same conditions as Test 39
resulted in low viscosity material until dried in drum
resulted in material having Bulk density—33.6 lb/ft³
   Test 42:
   Materials
   400 g DAP
   150 g De-ionized water
   100 g Attapolgite clay (Atta Clay)
   5.2 g Corn starch B810
   Process
used same conditions as Test 39
tended to over granulate
resulted in material having Bulk density—50.5 lb/ft³
   Test 43:
   Materials
   400 g AmSO₄ (industrial grade, milled—35)
   200 g De-ionized water
   50 g Perlite #1
   4.6 g corn starch B810
   Process
repeated conditions of Test 17, except with milled crystals
resulted in material having Bulk density—30.2 lb/ft³
   Test 44:
   Materials
   400 g AmSO₄ (industrial grade milled—35)
   200 g De-ionized water
   37 g Perlite 3-5
   4.6 g Corn starch B810
   Process
repeated conditions of Test 17, except with milled crystals
resulted in poor granulation
resulting material had Bulk density—23.2 lb/ft³ 45:
   Test 45:
   Materials
   400 g AmSO₄ (industrial grade milled—35)
   200 g De-ionized water
   50 g Cedar fines
   4.6 g Corn starch B810
   Process
repeated conditions of Test 17, except with milled crystals
resulted in good granulation
resulting material had Bulk density—26.9 lb/ft³
   Test 46:
   Materials
   400 g AmSO₄ (industrial grade milled—35)
   200 g De-ionized water
   100 g Attapolgite clay (Atta Clay)
   4.6 g Corn starch B810
   Process
repeated conditions of Test 17, except with milled crystals
tended to over granulate
resulted in material having Bulk density—48.6 lb/ft³
   Test 47:
   Materials
   520 g 40% P₂O₅ acid (phosphoric acid)
   206 g 29% NH₄OH +25 g add at bed
   68 g Perlite #1
   4.6 g Corn starch B810
   Process
placed phosphoric acid in beaker with stirring
slowly poured in NH₄OH
continued adding NH₄OH until all was in mixture
homogenized in the corn starch
poured slurry over rolling bed of pre-heated perlite
resulted in low viscosity intermediate; required much heating to evaporate the water
added 25 g of NH₄OH to bed to dry out
dried to free-flowing granules
resulting material was a MAP substance with a Bulk density—28.7 lb/ft³
   Test 48:
   Materials
   200 g De-ionized water
   550 g AmSO₄ fines
   50 g Cedar fines
   6.1 g Corn starch B810
   Process
repeated conditions of Test 21 using cedar fines
resulted in thick slurry
resulting material had Bulk density—29.7 lb/ft³
   Test 49:
   Materials
   225 g De-ionized water
   200 g CaSO₄.2H₂O
   200 g KCl (also known as Muriate of Potash) (milled—32)
   30 g Perlite #5
   5.0 g Corn starch B810
   Process
made slurry of water gypsum and KCL
resulted in slurry that was very thick and paste like
poured over rolling bed of perlite
tended to over granulate
resulting material had Bulk density—35.5 lb/ft³
   Test 50:
   Materials
   250 g de-ionized water
   250 g KCl (milled—32)
   50 g Perlite #1
   Process
heated water to boiling
slowly added KCl with stirring
allowed slurry to reach boiling again
poured slurry over rolling bed of pre-heated perlite
dried to free-flowing with a heat gun
resulting material had Bulk density—22.9 lb/ft³
   Test 51:
   Materials
   250 g De-ionized water
   250 g KCl
   50 g Perlite #1
   5 g Cornstarch B810
   Process
used same conditions as Test 50
Once slurry had reached a boil, the corn starch was homogenized in
slurry was poured over rolling bed of pre-heated perlite
dried to free-flowing with a heat gun
resulting material had Bulk density—23.3 lb/ft³
   Test 52:
   Materials
   300 g CaNO₃.5H₂O
   50 g Perlite #1
   Process
“Melted” CaNO₃.5H₂O on hot plate
poured over rolling bed of pre-heated perlite
attempted to dry with a heat gun, but when heat was added, became very slimy
dried at 50° C.
resulting material had Bulk density—37.5 lb/ft³
   Test 53:
   Materials
   329 g Urea
   3.2 g Cornstarch B-810
   17.39 g De-ionized water
   18 g Steamed perlite 3-S
   Process
created 95% urea melt and then added green dye
homogenized in the cornstarch, then stirred in perlite
granulated in drum
resulted in material having Bulk density—26.4 lb/ft³
   Test 54:
   Materials
   250 g De-ionized water
   400 g AmSO₄ fines
   4.6 g Cornstarch B-810
   4.6 g Attapolgite clay
   26 g Perlite 3-S
   Process
heated water to 200° F. and added AmSO₄
re-heated to 200° F. and homogenized in cornstarch
added attapolgite clay and homogenized
AmSO₄ stayed suspended
added perlite and stirred
drum granulated
resulting material had Bulk density—32.5 lb/ft³
   Test 55:
   Materials
   200 g De-ionized water
   400 g AmSO₄ (CO-60)
   26 g Perlite 3-S
   4.6 g Cornstarch
   Process
heated water to 200° F. and added AmSO₄
added cornstarch and homogenized
added perlite
drum granulated
resulted in material having Bulk density—28.2 lb/ft³
   Test 56:
   Materials
   200 g De-ionized water
   400 g AmSO₄
   26 g Perlite 3-S
   4.3 g Cornstarch
   Process
heated water to 200° F. and added AmSO₄
added cornstarch and homogenized
stirred in perlite
granulated in drum
resulted in material having Bulk density—26.8 lb/ft³
   Test 57:
   Materials
   200 g De-ionized water
   400 g AmSO₄
   26 g Perlite 3-S
   4.3 g Corn starch
   Process
heated water to 200° F. and added AmSO₄
added cornstarch and homogenized
stirred in perlite
granulated in drum
resulted in material having Bulk density—29.5 lb/ft³
   Test 58
   Materials
   200 g De-ionized water
   400 g AmSO₄ fines
   50 g Perlite 3-S (11%)
   2.3 g Corn starch B-810
   Process
heated water to 200° F. and added AmSO₄
reheated to 200° F. and added cornstarch (homogenized)
added perlite until no more would solubilize; added 50 grams of 3-S
granulated in drum with recycle
resulted in material having Bulk density—30.2 lb/ft³
   Test 59:
   Materials
   200 g De-ionized water
   400 g AmSO₄ fines
   26 g Perlite 3-S
   8.7 g Corn starch K-500 (2%)
   Process
heated water to 200° F. and added AmSO₄
reheated to 200° F. and added cornstarch (homogenized)
added perlite and drum granulated
resulted in material having Bulk density—29.8 lb/ft³
   Examples of Ammonium Sulfate Carrier and Mixed-in Pesticide
   Test 60:
   Materials
   400 g AmSO₄ Fines
   200 g De-ionized water
   4.6 g Corn starch
   26 g Perlite 3-S
   48.8 g Weed Out (18.2% Trimec Active)
(8.8 g Trimec Active)
   Process
heated AmSO₄ and water to 200° F.
added corn starch and homogenized
added Weed Out and stirred well
added Perlite and stirred well
granulated in drum
dried to free-flowing
resulted in material having Bulk density—31.1 lb/ft³
   Test 61:
   Materials
   400 g AmSO₄ Fines
   200 g De-ionized water
   4.6 g Corn starch (B810)
   26 g Perlite 3-S
   29.3 g Permethrin (30% Active)
(8.8 g Active)
   Process
heated AmSO₄ and water to 200° F.
added corn starch and homogenize
added Permethrin and stirred well
added Perlite and stirred well
granulated in drum
dried to free-flowing
resulted in material having Bulk density—29.2 lb/ft³
   Test 62:
   Materials
   200 g AmSO₄ Fines
   100 g De-ionized water
   2.8 Corn starch
   28 g Perlite #5
   26.2 g Weed Out (18.2% Trimec Active)
(4.7 g Active)
   Process
heated AmSO₄ and water to 200° F.
added corn starch and homogenize
added Weed Out and stirred well
placed Perlite in drum
poured mixture over rolling bed of Perlite
dried to free-flowing
resulted in material having Bulk density—25.4 lb/ft³
   Test 63:
   Materials
   200 g AmSO₄
   100 g De-ionized water
   2.8 g Corn starch
   28 g Perlite #5
   15.8 g Permethrin (30% Active)
(4.7 g Active)
   Process
heated AmSO₄ and water to 200° F.
added corn starch and homogenize
added Permethrin and stirred well
placed Perlite in drum
poured mixture over rolling bed of Perlite
dried to free-flowing
resulted in material having Bulk density—26.2 lb/ft³
   Examples of Ammonium Sulfate Carrier and Sprayed Pesticide

All pesticides were Permethrin

All products coated to 0.5% pesticide

Conditions of Tests A-D

Test A:

1.36 g Pesticide

98.6 g Batch (using the preceding described Test 29)

5 psi spray pressure

Test B:

1.36 g Pesticide

98.6 g Batch (using the preceding described Test 17)

5 psi spray pressure

Test C,

1.36 g Pesticide

98.6 g Batch (using the preceding described Test 24)

5 psi spray pressure

Test D:

1.36 g Pesticide

98.6 g Batch (using the preceding described Test 30)

5 psi spray pressure

The pesticide was sprayed using a peristaltic pump and air pressure using a 2850 air-atomizing nozzle. The material was coated in a drum to 0.5% pesticide.

All resulted in a good pesticide product.

Comments Regarding Performance of Tests and Test Results

All of Tests 1-9 employed ammonium sulfate because of its good solubility and pH which is neutral to most pesticides. Tests 1-9 were performed without granulation of the final mixture. All of Tests 1-9 included the addition of ammonium sulfate to 200° F. water while stirring to achieve a good mixture of AmSO₄ and water. Tests 1-9 enabled the determination of solution concentrations of ammonium sulfate and water that could be handled on a practical basis. Tests were conducted at 50, 60, 67, and 73 percent concentrations of ammonium sulfate in water.

Tests 5 and 6 provided for determining the mixtures which could be used with added corn starch at 1% of solids which was homogenized into the ammonium sulfate solution/slurry at both 67 and 73%. The results were successful in both cases.

In Tests 8 and 9, perlite was successfully mixed into the solution/slurry of corn starch, ammonium sulfate, and H₂O, at ammonium sulfate concentrations of both 67 and 73%.

Test 7 was performed to determine if use of large industrial grade crystals of ammonium sulfate could be used without grinding the large crystals. This did not work very well because they settled out of the slurry. Later tests employing ground (milled) crystals were successful. See tests 43 through 46.

Based on the results of Tests 1-9, additional tests were performed to see, if in particularly, ammonium sulfate could be incorporated with or without starch onto perlite while granulating the combination in a manner such that a pesticide incorporated and granulated with it or later sprayed on the outside surface of the resulting granules would be quickly available (released). Note that cedar fines contain a natural pesticide.

Two types of granulation were examined:
1) In Tests 10 through 16 and 20, the perlite was mixed with previously homogenized ammonium sulfate and corn starch (with the exception of Test 20, where no starch was employed) and then granulated by pouring it onto a rolling bed in a drum.
2) In Tests 17, 18, 21, 22, 23, and 24, the starch was homogenized and then poured on pre-heated perlite introduced to the rolling bed prior to pouring on the mixture. Test 19 used only ammonium sulfate (and no starch), which was poured onto the rolling bed of perlite particles for granulation.

The tests determined ranges of successful embodiments of the present invention, for example using concentrations of corn starch of 1, 1.6, and 2% and perlite concentrations of approximately 4, 6, 8.2, 9.2, and 11%. Ammonium sulfate concentrations of 62, 67, and 73% were used. Perlite size was also varied to include 3 grades with particles of median size by weight of 0.36 mm, 1.3 mm, and 2.4 mm. All of the tests showed good success; however, the presence of recycled product in the granulation drum from previous granulation tests were found particularly desirable for good granulation. Excellent results occurred when the perlite was pre-heated and placed in a rolling bed and the solution/slurry poured over it. As shown in Test 17, conditions for excellent granules were 11% perlite, 67% ammonium sulfate concentration, both 1.3 mm and 2.4 mm sized perlite and 2% corn starch. However, even without starch, the tests were successful, as shown in Test 19. Wheat starch was found to be a good substitute for corn starch, as shown in Tests 23, 25, 26, and 27.

Additional tests were performed to verify the success of other embodiments of the present invention, using other absorbent materials, including finely ground yellow pine chips (Test 25), milled newspaper (test 26), and ground corn cobs (Test 27). All were successful when granulated in the same manner as, for example in Test 17. The milled newspaper yielded a very good product, because less weight (of the newspaper) was required to obtain a fairly low density (32 lb/ft³) product.

Test 28 repeated Test 17, but employed 1% corn starch instead of 2% corn starch. This resulted in a little higher bulk density product, 28.6 lb/ft³ (Test 28) instead of 26.3 lb/ft³ (Test 17). Test 29 employed smaller perlite particles (1.3 mm) instead of perlite particles of 2.4 mm and resulted in a granule bulk density of 30.3 lb/ft³.

In Test 30, corn starch was employed in an amount of 1.6%; perlite content was 6%; and ammonium sulfate solution/slurry was 62%. The perlite was mixed into the solution/slurry prior to granulation, similar to Test 15, but yielding a lower bulk density product because of using the 62% ammonium sulfate solution/slurry.

Because all of the products granulated well, tests were performed to determine how the products would act as a pesticide carrier. See Tests A, B, C and D. Thus, 0.5% of Permethrin was sprayed on the particles in a rotating drum. The pesticide was sprayed using a peristaltic pump and pneumatically atomized using a Spraying Systems 2850 air atomizing nozzle with 5 psi air pressure. The materials sprayed and coated were those made in Tests 17, 24, 29, and 30. Thus, each test used 1.36 g of diluted pesticide, which was sprayed on 98.6 g of carrier. The pesticide applied well and the resulting granules were free flowing and demonstrated good physical handling characteristics, with no problems such as caking or granule deterioration.

Other carrier compositions were tested using the primary ingredients of urea (see Tests 31, 32, 33, 34); NPK (15-15-15), (see Tests 35, 36, 37, 38); diammonium phosphate (see Tests 39, 40, 41, 42); and milled industrial grade ammonium sulfate (see Tests 43, 44, 45, 46). In addition, cedar fines were tested as core particles of the carrier which contains a natural pesticide (see Tests 33, 37, 41, and 45). Attapolgite clay was employed in Tests 34, 38, 42, and 46. All resulted in good product.

Other tests were conducted to determine the feasibility of using diammonium phosphate (see Test 47), cedar fines with 73% ammonium sulfate (see Test 48), and a combination of gypsum and KCl, with a 50% solution concentration (see Tests 49, 50, 51). CaNO₃.5H₂O was melted and mixed with perlite and then poured onto a rolling bed to successfully make granular material suitable for a carrier (see Test 52).

In test 53, perlite, at 5%, was pre-steamed and stirred into a homogenous mixture of 1% corn starch, 95% urea solution, and a green dye. The mixture was granulated in a rotary drum.

In tests 54 through 57, the feasibility of using ammonium sulfate (CO-60, Honeywell) obtained as a by-product of caprolactam production was determined. No granulation difficulties were encountered using the premix of perlite method of granulation either by the inherent impurities of this ammonium sulfate or the proprietary anti-caking agent used by the manufacturer of the ammonium sulfate. Granulation of the material using this ammonium sulfate was considered equal or better to pure or industrial grade ammonium sulfate.

In test 58, caprolactam by-product ammonium sulfate (CO-60, Honeywell) was used with only 0.5% corn starch and 11% perlite stirred into the mixture before it was granulated in a rolling bed in a drum. Again granulation was good, as was the case in Test 59, when ethylated corn starch (K-500) was used at 2% by weight of the carrier product instead of the previously used modified corn starch. Once again in Test 59, the ammonium sulfate was a caprolactam by-product

Several herbicide and insecticide carrier materials were produced utilizing two methods of drum granulation techniques. The first granulation technique performed during these tests is referred to as the pre-mix and drum granulation method. In Tests 60 and 61 ammonium sulfate carrier granules were produced by the following procedure.

Test #60

Approximately 200 grams of de-ionized water was heated to 200° F. Finely ground ammonium sulfate crystals was added (400 grams) to the water to produces a 67% solution/slurry. Corn starch (B810) was added (4.6 grams) (1% by weight) to the ammonium sulfate solution/slurry and homogenized to produce a homogenous mixture.

Approximately 2% active agent herbicide was added to the ammonium sulfate and corn starch solution/slurry to perform Test 60. The herbicide contained TRIMEC. TRIMEC is composed of dimethylamine salt of 2-(2-methyl-4-chlorophenoxy)propionic acid, dimethylamine of 2,4-dichlorophenoxyacetic acid, dimethylamine salt of dicamba (3,6-dichloro-O-anisic acid). The herbicide was added to the slurry and stirred. Perlite 3-S was incorporated into the solution slurry of ammonium sulfate, water, cornstarch, and herbicide and stirred to produce a homogenous mixture. The mixture was poured into a drum granulator to promote granulation of the material. Hot air was blown into the granulation drum to remove the moisture of the mixture until the particles were free flowing and granules were formed. The granules were removed from the granulation drum and placed in a lab oven at 125° F. for further drying.

Test #61

Approximately 200 grams of de-ionized water was heated to 200° F. Finely ground ammonium sulfate crystals was added (400 grams) to the water to produces a 67% solution/slurry. Corn starch (B810) was added (4.6 grams) (1% by weight) to the ammonium sulfate solution/slurry and homogenized to produce a homogenous mixture.

Approximately 2% active agent insecticide was added to the ammonium sulfate and corn starch solution/slurry to perform Test 61. The insecticide was Permethrin ((3-phenoxyphenyl)methyl-3-(2,2-dichlorovinyl)-2,2-dimethylcyclopropanecarboxylate). The insecticide was added to the slurry and stirred. Perlite 3-S was incorporated into the solution slurry of ammonium sulfate, water, cornstarch, and insecticide and stirred to produce a homogenous mixture. The mixture was poured into a drum granulator to promote granulation of the material. Hot air was blown into the granulation drum to remove the moisture of the mixture until the particles were free flowing and granules were formed. The granules were removed from the granulation drum and placed in a lab oven at 125° F. for further drying.

The second granulation technique performed during these tests is referred to as the drum over-coating granulation method. In Tests 62 and 63 ammonium sulfate carrier granules were produced by the following procedure.

Test #62

Approximately 200 grams of de-ionized water was heated to 200° F. Finely ground ammonium sulfate crystals were added (400 grams) to the water to produces a 67% solution/slurry. Corn starch (B810) was added (4.6 grams) (1% by weight) to the ammonium sulfate solution/slurry and homogenized to produce a homogenous mixture.

Approximately 2% active agent herbicide was added to the ammonium sulfate and corn starch solution/slurry to perform Test # 62. The herbicide contained TRIMEC. TRIMEC is composed of dimethylamine salt of 2-(2-methyl-4-chlorophenoxy)propionic acid, dimethylamine of 2,4-dichlorophenoxyacetic acid, dimethylamine salt of dicamba (3,6-dichloro-O-anisic acid). The herbicide was added to the slurry and stirred.

Perlite #5 was added (28 grams) to the drum granulator and preheated to aid in granulation and moisture removal of the mixture. The slurry/solution of ammonium sulfate, water, corn starch, and TRIMEC was poured onto the rolling bed of perlite. Hot air was blown into the granulation drum to remove the moisture of the mixture until the particles were free flowing and granules were formed. The granules were removed from the granulation drum and placed in a lab oven at 125° F. for further drying.

Test #63

Approximately 200 grams of de-ionized water was heated to 200° F. Finely ground ammonium sulfate crystals were added (400 grams) to the water to produces a 67% solution/slurry. Corn starch (B810) was added (4.6 grams) (1% by weight) to the ammonium sulfate solution/slurry and homogenized to produce a homogenous mixture.

Approximately 2% active agent insecticide was added to the ammonium sulfate and corn starch solution/slurry to perform Test 63. The insecticide was Permethrin ((3-phenoxyphenyl)methyl-3-(2,2-dichlorovinyl)-2,2-dimethylcyclopropanecarboxylate). The insecticide was added to the slurry of ammonium sulfate, water, and corn starch and stirred.

Perlite #5 was added (28 grams) to the drum granulator and preheated to aid in granulation and moisture removal of the mixture. The slurry/solution of ammonium sulfate, water, corn starch, and Permethrin was poured onto the rolling bed of perlite. Hot air was blown into the granulation drum to remove the moisture of the mixture until the particles were free flowing and granules were formed. The granules were removed from the granulation drum and placed in a lab oven at 125° F. for further drying.

Particles produced in Tests 60-63 were placed in a petri dish and submerged with de-ionized water and visually observed with a laboratory stereoscope to identify the initial release characteristics of the pesticide carrier granules. Visual observations of the granules that were submerged in water showed rapid particle breakdown, presumably enhanced by the release of stored energy within the particles. This particle breakdown increased the surface area of the inoculated materials containing the pesticide (herbicide or insecticide) by 2 to 10 times the surface area of the starting particles. Thus, excellent, fast pesticide release characteristics were observed.

TABLE 1
PESTICIDE CARRIER GRANULATION TEST RESULTS AND OBSERVATIONS

| TEST | NUTRIENT | SOLUTION | STARCH | STARCH | ABSORBENT | ABSORBENT |
|---|---|---|---|---|---|---|
| # | TYPE | CONC(%) | TYPE | CONC(%) | TYPE | CONC(%) |
| 10 | AmSO4 FINES | 67 | CORN | 1 | PERLITE 3-S | 4 |
| 11 | AmSO4 FINES | 67 | CORN | 1 | PERLITE 3-S | 4 |
| 12 | AmSO4 FINES | 67 | CORN | 2 | PERLITE 3-S | 4 |
| 13 | AmSO4 FINES | 67 | CORN | 2 | PERLITE 3-S | 4 |
| 14 | AmSO4 FINES | 67 | CORN | 1.6 | PERLITE 3-S | 6 |
| 15 | AmSO4 FINES | 67 | CORN | 1.6 | PERLITE 3-S | 6 |
| 16 | AmSO4 FINES | 62 | CORN | 1.6 | PERLITE 3-S | 6 |
| 17 | AmSO4 FINES | 67 | CORN | 2 | PERLITE #5 | 10.9 |
| 18 | AmSO4 FINES | 67 | CORN | 1 | PERLITE #5 | 10.9 |
| 19 | AmSO4 FINES | 67 | N/A | 0 | PERLITE #5 | 11.1 |
| 20 | AmSO4 FINES | 67 | N/A | 0 | PERLITE 3-S | 6.1 |
| 21 | AmSO4 FINES | 73 | CORN | 2 | PERLITE #5 | 8.2 |
| 22 | AmSO4 FINES | 73 | CORN | 2 | PERLITE 3-S | 4.3 |
| 23 | AmSO4 FINES | 67 | WHEAT | 2 | PERLITE #5 | 10.9 |
| 24 | AmSO4 FINES | 67 | CORN | 2 | PERLITE #1 | 10.9 |
| 25 | AmSO4 FINES | 67 | WHEAT | 1.9 | PINE CHIPS | 15.5 |
| 26 | AmSO4 FINES | 67 | WHEAT | 2.1 | NEWSPAPER | 4.7 |
| 27 | AmSO4 FINES | 67 | WHEAT | 1.9 | CORNCOB | 15.5 |
| 28 | AmSO4 FINES | 67 | CORN | 1 | PERLITE #5 | 10.9 |
| 29 | AmSO4 FINES | 67 | CORN | 2 | PERLITE #1 | 10.9 |
| 30 | AmSO4 FINES | 62 | CORN | 1.6 | PERLITE 3-S | 6 |
| 31 | UREA | 85 | CORN | 1 | PERLITE #1 | 8.5 |
| 32 | UREA | 85 | CORN | 1 | PERLITE 3-S | 7.6 |
| 33 | UREA | 85 | CORN | 1 | CEDAR FINES | 10 |
| 34 | UREA | 85 | CORN | 1 | ATTA CLAY | 20 |
| 35 | NPK(15-15-15) | 85 | CORN | 1 | PERLITE #1 | 8.5 |
| 36 | NPK(15-15-15) | 85 | CORN | 1 | PERLITE 3-S | 7.7 |
| 37 | NPK(15-15-15) | 85 | CORN | 1 | CEDAR FINES | 10.4 |
| 38 | NPK(15-15-15) | 85 | CORN | 1 | ATTA CLAY | 20 |
| 39 | DAP FINES | 67 | CORN | 1 | PERLITE #1 | 15.6 |
| 40 | DAP FINES | 73 | CORN | 1 | PERLITE 3-S | 8 |
| 41 | DAP FINES | 73 | CORN | 1 | CEDAR FINES | 11 |
| 42 | DAP FINES | 73 | CORN | 1 | ATTA CLAY | 19.8 |
| 43 | AmSO4 FINES(IND) | 67 | CORN | 1 | PERLITE #1 | 11 |
| 44 | AmSO4 FINES(IND) | 67 | CORN | 1 | PERLITE 3-S | 8.4 |
| 45 | AmSO4 FINES(IND) | 67 | CORN | 1 | CEDAR FINES | 11 |
| 46 | AmSO4 FINES(IND) | 67 | CORN | 1 | ATTA CLAY | 19.8 |
| 47 | MAP SLURRY | N/A | CORN | 1 | PERLITE #1 | 19.6 |
| 48 | AmSO4 FINES | 73 | CORN | 1 | CEDAR FINES | 8.3 |
| 49 | KCl/CaSO4*2H2O | 64 | CORN | 1 | PERLITE #5 | 6.9 |
| 50 | KCl(MURIATE) | 50 | CORN | 1 | PERLITE #1 | 16.7 |
| 51 | KCl(MURIATE) | 50 | CORN | 1.6 | PERLITE #1 | 16.4 |
| 52 | CaNO3*2H2O | 100 | CORN | 1 | PERLITE #1 | 14.3 |
| 53 | UREA | 95 | CORN | 1 | PERLITE 3-S | 5.1 |
| 54 | AmSO4 FINES(HW) | 62 | CORN | 1 | PERLITE 3-S | 6.0 |
| 55 | AmSO4 FINES(HW) | 67 | CORN | 1 | PERLITE 3-S | 6.0 |
| 56 | AmSO4 FINES(HW) | 67 | CORN | 1 | PERLITE 3-S | 6.0 |
| 57 | AmSO4 FINES(HW) | 67 | CORN | 1 | PERLITE 3-S | 6.0 |
| 58 | AmSO4 FINES(HW) | 67 | CORN | 0.5 | PERLITE 3-S | 11.1 |
| 59 | AmSO4 FINES(HW) | 67 | CORN | 2 | PERLITE 3-S | 6.0 |
| 60 | AmSO4 FINES(HW) | 67 | CORN | 1 | PERLITE 3-S | 5.9 |
| 61 | AmSO4 FINES(HW) | 67 | CORN | 1 | PERLITE 3-S | 5.9 |
| 62 | AmSO4 FINES(HW) | 67 | CORN | 1 | PERLITE #5 | 11.9 |
| 63 | AmSO4 FINES(HW) | 67 | CORN | 1 | PERLITE #5 | 11.9 |

| TEST | BULK | GRANULATION | |
|---|---|---|---|
| # | DENSITY(#/FT3) | METHOD | COMMENTS |
| 10 | N/A | PRE-MIXED/DRUM GRANULATION | POOR GRANULATION |
| 11 | 41.9 | PRE-MIXED/DRUM GRANULATION | GOOD GRANULATION |
| 12 | N/A | PRE-MIXED/DRUM GRANULATION | POOR GRANULATION |
| 13 | 43.2 | PRE-MIXED/DRUM GRANULATION | GOOD GRANULATION |
| 14 | N/A | PRE-MIXED/DRUM GRANULATION | POOR GRANULATION |
| 15 | 39.7 | PRE-MIXED/DRUM GRANULATION | GOOD GRANULATION |
| 16 | 38.6 | PRE-MIXED/DRUM GRANULATION | GOOD GRANULATION |
| 17 | 26.3 | DRUM OVERCOAT/GRANULATION | GOOD GRANULATION |
| 18 | 26.4 | DRUM OVERCOAT/GRANULATION | GOOD GRANULATION |
| 19 | 29.3 | DRUM OVERCOAT/GRANULATION | GOOD GRANULATION |
| 20 | 35.1 | PRE-MIXED/DRUM GRANULATION | GOOD GRANULATION |
| 21 | 34.1 | DRUM OVERCOAT/GRANULATION | GOOD GRANULATION |
| 22 | 39.1 | DRUM OVERCOAT/GRANULATION | GOOD GRANULATION |
| 23 | 30.9 | DRUM OVERCOAT/GRANULATION | GOOD GRANULATION |
| 24 | 27.6 | DRUM OVERCOAT/GRANULATION | GOOD GRANULATION |
| 25 | 29.6 | DRUM OVERCOAT/GRANULATION | GOOD GRANULATION |
| 26 | 32.5 | DRUM OVERCOAT/GRANULATION | FAIR GRANULATION |
| 27 | 34.0 | DRUM OVERCOAT/GRANULATION | FAIR GRANULATION |
| 28 | 28.6 | DRUM OVERCOAT/GRANULATION | GOOD GRANULATION |
| 29 | 30.3 | DRUM OVERCOAT/GRANULATION | GOOD GRANULATION |
| 30 | 33.1 | PRE-MIXED/DRUM GRANULATION | GOOD GRANULATION |
| 31 | 24.6 | DRUM OVERCOAT/GRANULATION | GOOD GRANULATION |
| 32 | 17.3 | DRUM OVERCOAT/GRANULATION | GOOD GRANULATION |
| 33 | 20.6 | DRUM OVERCOAT/GRANULATION | GOOD GRANULATION |
| 34 | 32.8 | DRUM OVERCOAT/GRANULATION | GOOD GRANULATION |
| 35 | 35.1 | DRUM OVERCOAT/GRANULATION | GOOD GRANULATION |
| 36 | 34.4 | DRUM OVERCOAT/GRANULATION | GOOD GRANULATION |
| 37 | 35.7 | DRUM OVERCOAT/GRANULATION | GOOD GRANULATION |
| 38 | 49.4 | DRUM OVERCOAT/GRANULATION | GOOD GRANULATION |
| 39 | 31.0 | DRUM OVERCOAT/GRANULATION | GOOD GRANULATION |
| 40 | 37.4 | DRUM OVERCOAT/GRANULATION | GOOD GRANULATION |
| 41 | 33.6 | DRUM OVERCOAT/GRANULATION | GOOD GRANULATION |
| 42 | 50.5 | DRUM OVERCOAT/GRANULATION | GOOD GRANULATION |
| 43 | 30.2 | DRUM OVERCOAT/GRANULATION | GOOD GRANULATION |
| 44 | 23.2 | DRUM OVERCOAT/GRANULATION | POOR GRANULATION |
| 45 | 26.9 | DRUM OVERCOAT/GRANULATION | GOOD GRANULATION |
| 46 | 48.6 | DRUM OVERCOAT/GRANULATION | GOOD GRANULATION |
| 47 | 28.7 | DRUM OVERCOAT/GRANULATION | GOOD GRANULATION |
| 48 | 29.7 | DRUM OVERCOAT/GRANULATION | GOOD GRANULATION |
| 49 | 35.5 | DRUM OVERCOAT/GRANULATION | GOOD GRANULATION |
| 50 | 22.9 | DRUM OVERCOAT/GRANULATION | GOOD GRANULATION |
| 51 | 23.3 | DRUM OVERCOAT/GRANULATION | GOOD GRANULATION |
| 52 | 37.5 | DRUM OVERCOAT/GRANULATION | GOOD GRANULATION |
| 53 | 26.4 | PRE-MIXED/DRUM GRANULATION | GOOD GRANULATION |
| 54 | 32.5 | PRE-MIXED/DRUM GRANULATION | 1% ATTA CLAY WITH |
| | | | CS |
| 55 | 28.2 | PRE-MIXED/DRUM GRANULATION | GOOD GRANULATION |
| 56 | 26.8 | PRE-MIXED/DRUM GRANULATION | GOOD GRANULATION |
| 57 | 29.5 | PRE-MIXED/DRUM GRANULATION | GOOD GRANULATION |
| 58 | 30.2 | PRE-MIXED/DRUM GRANULATION | GOOD GRANULATION |
| 59 | 29.8 | PRE-MIXED/DRUM GRANULATION | GOOD GRANULATION |
| 60 | 31.1 | PRE-MIXED/DRUM GRANULATION | 2% TRIMEC ACTIVE |
| | | | AGENT |
| 61 | 29.2 | PRE-MIXED/DRUM GRANULATION | 2% PERMETHRIN |
| | | | ACTIVE AGENT |
| 62 | 25.4 | DRUM OVERCOAT/GRANULATION | 2% TRIMEC ACTIVE |
| | | | AGENT |
| 63 | 26.2 | DRUM OVERCOAT/GRANULATION | 2% PERMETHRIN |
| | | | ACTIVE AGENT |

While only a few exemplary embodiments of this invention have been described in detail, those skilled in the art will recognize that there are many possible variations and modifications which may be made in the exemplary embodiments while yet retaining many of the novel and advantageous features of this invention. Accordingly, it is intended that the following claims cover all such modifications and variations.

1. A pesticide carrier composition comprising:
a core particles composed of smaller particles agglomerated into granules, the core particles having
absorbent voids and pores within and on the surface, and
a rough absorbent surface; and
a pesticide release material that is water soluble and is at least one of, present on the surface and absorbed within the core particle.

2. (canceled)

3. The composition of claim 1, wherein the core particles include a filler/release control agent present as a coating or mixed with the pesticide release material.

4. The composition of claim 3 wherein the filler/release control agent is one of corn starch and wheat starch.

5. The composition of claim 3, wherein the filler/release control agent is a coating on the pesticide release material.

6. The composition of claim 1, wherein the core particles contain pores or voids, such that the voids at the surface are between 10-200 microns in cross-sectional diameter.

7. The composition of claim 6, wherein the surface has a coating of pesticide release material in an amount wherein 40-100% of the voids contain the pesticide release material.

8. The composition of claim 1, wherein the core particles include a material selected from the group consisting of expanded perlite, exfoliated perlite, shredded newspaper, saw dusts, cedar fines, spruce fines, hardwood fines, limestone, zeolite, peat moss, peanut hulls, calcium carbonate, wood chips including pine chips and fines, attapulgite clay (atta clay), bentonite, vermiculite, cotton lint, ground corn cobs, corn cob flower, Metrecz absorbent and diatomaceous earth.

9. The composition of claim 1, wherein the pesticide release material includes a material selected from the group consisting of ammonium sulfate, urea, di-ammonium phosphate, potassium chloride, calcium nitrate, potassium sulfate, zinc sulfate, aluminum sulfate, magnesium sulfate, manganese sulfate, sodium nitrate, potassium nitrate, copper sulfate, boric acid, borax (e.g., 5 mole borax), mono ammonium phosphate, calcium phosphate, and single and triple super phosphate.

10. The composition of claim 3 wherein the filler/release control agent is a material selected from the group consisting of plant starches, protein gels, glues, gumming compositions, crystallizing compounds, gelling clays, and synthetic gel forming compounds; and other plant starches, protein gels and glues, gumming products, crystallizing compounds, gelling clays, and synthetic gel forming compounds also work as the filler/release control agent.

11. The composition of claim 3, wherein the filler/release control agent is a material selected from the group consisting of corn starch, rice starch, potato starch, wheat starch, tapioca starch, and any starch which contains the D-glucopyranose polymers, amylose and amylopectin; starches modified by acetylation, ethylation, chlorination, acid hydrolysis, or enzymatic action which yield starch acetates, esters, and ethers; starch phosphate, an ester made from the reaction of a mixture of orthophosphate salts (sodium dihydrogen phosphate and disodium hydrogen phosphate) with starches; gelatin as made by hydrolysis of collagen by treating raw materials with acid or alkali; glue as made from collagen, casein, blood, and vegetable protein including from soybeans; gumming products such as cellulosics, rubber latex, gums, terpene resins, mucilages, asphalts, pitches, hydrocarbon resins; crystallizing compounds including sodium silicate, phosphate cements, calcium-oxide cements, hydraulic cements, mortar, gypsum; gelling clays in the form of very fine powders; synthetic gel forming compounds including polysulfide sealants, polyethylene, isobutylene, polyamides, polyvinyl acetate, epoxy, phenolformaldehyde, urea formaldehyde, polyvinyl butyral, cyanoacrylates, and silicone cements.

12. The composition of claim 1, wherein the pesticide release material contains fertilizer including compounds selected from the group consisting of nitrogen compounds, phosphorous compounds and potassium compounds.

13. The composition of claim 12, wherein the nitrogen compounds are selected from the group consisting of urea, ammonia, ammonium nitrate, ammonium sulfate, calcium nitrate, diammonium phosphate, monoammonium phosphate, potassium nitrate and sodium nitrate.

14. The composition of claim 12, wherein the phosphorous compounds are selected from the group consisting of diammonium phosphate, monoammonium phosphate, calcium phosphate, monopotassium phosphate, dipotassium phosphate, tetrapotassium pyrophosphate, and potassium metaphosphate.

15. The composition of claim 12, wherein the potassium compounds are selected from the group consisting of potassium chloride, potassium nitrate, potassium sulfate, monopotassium phosphate, dipotassium phosphate, tetrapotassium pyrophosphate, and potassium metaphosphate.

16. The composition of claim 1, wherein the pesticide release material contains secondary nutrients including compounds selected from the group consisting of sulfur, calcium, and magnesium.

17. The composition of claim 1, wherein the pesticide release material contains micronutrients selected from the group consisting of boron, copper, iron, manganese, molybdenum, and zinc.

18. The composition of claim 1, wherein the pesticide release material contains growth regulators selected from the group consisting of potassium azide, 2 amino-4-chloro-6-methyl pyrimidine, N-(3,5-dichlorophenyl)succinimide, and 3-amino-1,2,4 triazole.

19. The composition of claim 1, wherein the pesticide release material contains nitrification regulators selected from the group consisting of 2-chloro-6-(trichloromethyl)pyridine, sulfathiazole, dicyandiamide, thiourea, and guanylthiourea.

20. The composition of claim 1, wherein the pesticide release material contains a combined nitrogen-phosphorus-potassium (NPK) fertilizer in the proportions selected from the group consisting of 29-3-4, 16-4-8, 10-10-10, 15-5-10, 15-0-15, 22-3-14, 20-28-5, 35-3-9, 38-3-4 and 12-6-6.

21. The composition of claim 8, wherein the perlite is exfoliated/expanded perlite having cell diameters of 10 to 200 microns.

22. The composition of claim 8, wherein the perlite is exfoliated/expanded perlite having a loose weight density of from 2 to 20 lb/ft³.

23. A pesticide product comprising:
a pesticide carrier composition comprising:
core particles composed of smaller particles agglomerated into granules, the core particles having
absorbent voids and pores within and on the surface, and a rough absorbent surface, and
a pesticide release material that is water soluble and
is at least one of, present on the surface and absorbed
within the core particles; and
a pesticide present in at least one of a coating on the surface of the carrier composition and mixed with the pesticide release material.

24. The pesticide product of claim 23, wherein the pesticide product has a weight density of from 15 to 65 lb/ft³.

25. The pesticide product of claim 23, wherein the pesticide product has a size of 0.20 mm to 25 mm.

26. The pesticide product of claim 23, wherein the pesticide is selected from the group consisting of herbicides, insecticides and fungicides.

27. The pesticide product of claim 23, wherein the pesticide is selected from the group consisting of
O,O-diethyl O-(2-isopropyl-6 methyl-4 pyrimidinyl;
phosphorothioate) 2,4-dichlorophenoxyacetic acid;
ferric-di-methyl-dithiocarbamate;
2-(2-Methyl-4-chlorophenoxy)propionic acid;
2-Methyl-4-chlorophenoxyacetic acid;
3,6-Dichloro-o-anisic acid;
pyrethrins;
2-chloro-4-ethylamino-s-triazine;
N-butyl-N-ethyl-alpha, alpha, alpha, trifluoro-2,6-dinitro-p-toluidine (benefin);
alpha, alpha, alpha, trifluoro-2, trifluoro-2,6-dinitro-N,N-dipropyl-p-toluidine (trifluralin);
Dithiopyr 3,5-pyridenedicarbothiocic acid, 2-(difluoromethyl)-4-(2-methylpropyl)-6-(trifluoromethyl)-S, S-dimethyl ester;
chlorpyrifos(O,O-diethyl-O-(3,5,6-trichloro-2-pyridyl)phosphorothioate;
O,O-Diethyl S-(2-(ethylthio)ethyl)phosphorodithioate;
(2,2,2-trichloro-1-hydroxethyl)phosphonate;
1-((6-chloro-3-pyridinyl)methyl)-N-nitro-2-imidazolidinimine;
cyano(4-fluoro-3-phenoxyphenyl)methyl 3-(2,2-dichloroethenyl)-2,2-dimethylcyclopropane carboxylate;
(2,4,6,8-tetramethyl-1,3,5,7-tetraoxycyclo-octane); and
(N3, N3-Di-n-propyl-2,4-nitro-6(trifluoromethyl)-m-phenylenediamine) (Prodiamine).

28. The pesticide product of claim 23, further including a coating of fertilizer including compounds selected from the group consisting of nitrogen compounds, phosphorous compounds and potassium compounds.

29. The composition of claim 1, wherein the agglomerated smaller particles are particles of absorbent material.

30. The composition of claim 29, wherein the absorbent material is selected from the group consisting of expanded perlite, exfoliated perlite, shredded newspaper, saw dusts, cedar fines, spruce fines, hardwood fines, zeolite, peat moss, peanut hulls, wood chips including pine chips and fines, attapulgite clay (atta clay), bentonite, vermiculite, cotton lint, ground corn cobs, corn cob flower, Metrecz absorbent and diatomaceous earth.

31. A pesticide product comprising:
a pesticide carrier composition comprising:
core particles composed of smaller particles of expanded or exfoliated perlite agglomerated into granules, the core particles having absorbent voids and pores within and on the surface, and a rough absorbent surface, and
a pesticide release material selected from the group consisting of urea and ammonium sulfate that is at least one of, present on the surface and absorbed within the core particles, the pesticide release material further including fertilizer compounds selected from the group consisting of nitrogen compounds, phosphorous compounds and potassium compounds; and
a pesticide present in at least one of a coating on the surface of the carrier composition and mixed with the pesticide release material.

32. A pesticide product comprising:
a pesticide carrier composition comprising:
core particles composed of smaller particles of expanded or exfoliated perlite agglomerated into granules, the core particles having absorbent voids and pores within and on the surface, and a rough absorbent surface, and
a pesticide release material selected from the group consisting of urea and ammonium sulfate that is at least one of, present on the surface and absorbed within the core particles; and
a pesticide present in at least one of a coating on the surface of the carrier composition and mixed with the pesticide release material.
